(19) United States
(12) Patent Application Publication
(10) Pub. No.: US 2025/0205902 A1
(43) Pub. Date: Jun. 26, 2025

(54) INFORMATION PROCESSING DEVICE, INFORMATION PROCESSING METHOD, AND STORAGE MEDIUM

(71) Applicant: CASIO COMPUTER CO., LTD., Tokyo (JP)

(72) Inventor: Kouki MAYUZUMI, Tokyo (JP)

(73) Assignee: CASIO COMPUTER CO., LTD., Tokyo (JP)

(21) Appl. No.: 18/982,229

(22) Filed: Dec. 16, 2024

(30) Foreign Application Priority Data
Dec. 22, 2023 (JP) 2023-216540

(51) Int. Cl. B25J 13/08; A63H 13/00

(52) U.S. Cl. CPC B25J 13/08; A63H 13/005; A63H 2200/00

(57) ABSTRACT

An information processing device includes a processor. The processor stores, in a storage, a piece of correspondence information in which a detection result by a sensor at a certain time point, the sensor being included in a robot for detecting at least one action from a user, is correlated with presence or absence of a predetermined action from outside to the robot within a predetermined period including the certain time point. Based on pieces of correspondence information stored in the storage and corresponding to time points different from one another, the pieces of correspondence information each being the piece of correspondence information, the processor makes a prediction for an action that the robot receives from the user at a specific time point after the time points.

### REFERENCE TO RELATED APPLICATIONS

This application is based upon and claims the benefit of priority from the prior Japanese Patent Application No. 2023-216540, filed on Dec. 22, 2023, the entire contents of which are incorporated herein by reference.

### TECHNICAL FIELD

The present disclosure relates to an information processing device, an information processing method, and a storage medium.

### DESCRIPTION OF RELATED ART

There has been a technique of causing a robot provided with a camera to make a motion in accordance with the situation around the robot, such as the position of its user, on the basis of an image of the surroundings of the robot 1 taken with the camera. (Refer to, for example, WO 2019/151387 A1.)

### SUMMARY OF THE INVENTION

According to an aspect of the present disclosure, there is provided an information processing device including a processor that
stores, in a storage, a piece of correspondence information in which a detection result by a sensor at a certain time point, the sensor being included in a robot for detecting at least one action from a user, is correlated with presence or absence of a predetermined action from outside to the robot within a predetermined period including the certain time point, and
based on pieces of correspondence information stored in the storage and corresponding to time points different from one another, the pieces of correspondence information each being the piece of correspondence information, makes a prediction for an action that the robot receives from the user at a specific time point after the time points.

### BRIEF DESCRIPTION OF DRAWINGS

FIG. 1 illustrates the appearance of a robot.

FIG. 2 is a schematic view illustrating the configuration of a main part of the robot.

FIG. 3 is a block diagram illustrating a functional configuration of the robot.

FIG. 4 schematically illustrates transition of the operation state of the robot.

FIG. 5 illustrates the contents of gesture setting data.

FIG. 6 illustrates the contents of motion elements.

FIG. 7 is a flowchart illustrating a control procedure for a gesture learning process.

FIG. 8 illustrates the contents of situation data.

FIG. 9 illustrates an example of a relationship between an action-received timing and a sensor-data-generated timing.

FIG. 10 illustrates an example of a relationship between an action-received timing in response to a gesture and a sensor-data-generated timing.

FIG. 11 is a flowchart illustrating a control procedure for a robot control process.

FIG. 12 is a flowchart illustrating a control procedure for a situation recording process.

FIG. 13 is a flowchart illustrating a control procedure for an action predicting process.

FIG. 14 is a flowchart illustrating a control procedure for a gesture result waiting process.

FIG. 15 is a flowchart illustrating a control procedure for a regression formula learning process.

### DETAILED DESCRIPTION

Hereinafter, one or more embodiments will be described with reference to the drawings.

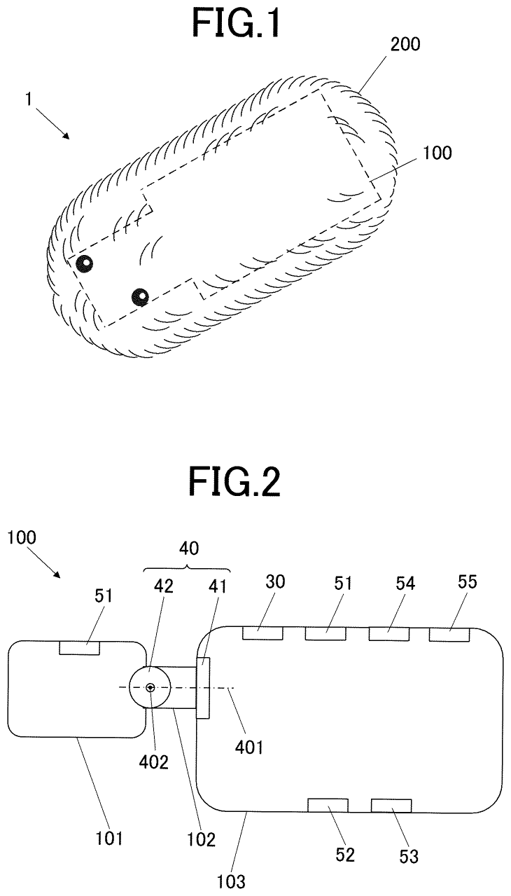

FIG. 1 illustrates the appearance of a robot 1. The robot 1 includes a main part 100 and an exterior 200 that covers the main part 100. The robot 1 is a pet robot made to simulate a small living creature. The robot 1 can make gestures (motions) different from one another. Examples of the gestures include a gesture of moving a head (and a neck) and a gesture of making a cry. The exterior 200 deforms as the main part 100 moves. The exterior 200 includes a fur made of pile fabric and decorative members resembling eyes.

FIG. 2 is a schematic view illustrating the configuration of the main part 100 of the robot 1. The main part 100 includes a head 101, a trunk (torso) 103 and a coupler 102 that couples the head 101 to the trunk 103. The main part 100 also includes a driver 40 that moves the head 101 with respect to the trunk 103. The driver 40 includes a twist motor 41 and a vertical motion motor 42. The twist motor 41 is a servo motor that rotates the head 101 and the coupler 102 within a predetermined angle range around a first rotation axis 401 extending in the extending direction of the coupler 102. The twist motor 41 operates to cause the robot 1 to turn its head (twist its neck). The vertical motion motor 42 is a servo motor that rotates the head 101 within a predetermined angle range around a second rotation axis 402 perpendicular to the first rotation axis 401. The vertical motion motor 42 operates to cause the robot 1 to move its head up and down. The direction of the up-and-down movement of the head may be an inclined direction with respect to the vertical direction depending on the angle of the turn of the head by the twist motor 41. Causing the twist motor 41 and/or the vertical motion motor 42 to operate frequently (rapidly) and/or cyclically can cause the robot 1 to shake its head or quiver. Appropriately changing and combining timings, magnitudes and speeds of the operations of the twist motor 41 and the vertical motion motor 42 can cause the robot 1 to make various gestures.

The main part 100 also includes touch sensors 51, an acceleration sensor 52, a gyro sensor 53, an illuminance sensor 54, a microphone 55 and a sound outputter 30. The touch sensors 51 are disposed at the upper parts of the head 101 and the trunk 103. The illuminance sensor 54, the microphone 55 and the sound outputter 30 are disposed at the upper part of the trunk 103. The acceleration sensor 52 and the gyro sensor 53 are disposed at the lower part of the trunk 103.

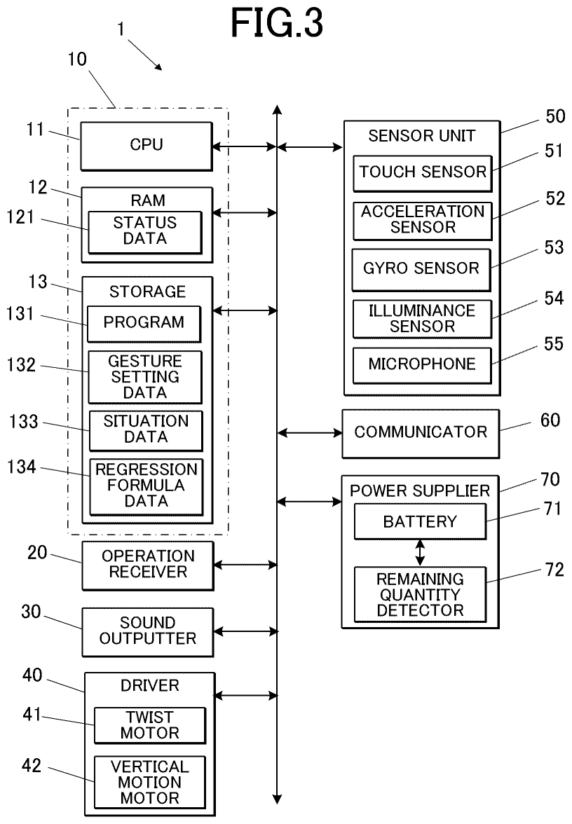

FIG. 3 is a block diagram illustrating a functional configuration of the robot 1. All functional components illustrated in FIG. 3 are disposed in/on the main part 100. The robot 1 includes a central processing unit (CPU) 11, a random access memory (RAM) 12, a storage 13, an operation receiver 20, a sound outputter 30, which is mentioned above, a driver 40, which is mentioned above, a sensor unit 50 (sensor(s)), the components of which are mentioned above, a communicator 60, and a power supplier 70. These components of the robot 1 are connected with one another via a communication path, such as a bus. The CPU 11, the RAM 12 and the storage 13 constitute a robot control device 10 (information processing device) that controls operation of the robot 1.

The CPU 11 is a processor that controls the operation of the robot 1 by reading and executing programs 131 stored in the storage 13 to perform various types of arithmetic processing. The robot 1 may have two or more processors (e.g., two or more CPUs), and two or more processes that are performed by the CPU 11 of this embodiment may be performed by the processors. In this case, the processors constitute the aforementioned processor. The processors may be involved in the same processes or independently perform different processes in parallel.

The RAM 12 provides the CPU 11 with a memory space for work and stores temporary data. The RAM 12 stores status data 121 that indicates the status (state) of the robot 1. The status data 121 is rewritten and referred to in a robot control process described later. The status indicated by the status data 121 is any of the following three: “Idle State”, “Gesture Result Waiting State” and “Learning State”. Of these, the idle state is a state in which the robot 1 waits for an action from outside, which hereinafter may be referred to as an “external action”, and determines whether to make a spontaneous gesture on the basis of an analysis result of the situation of its surroundings.

The storage 13 is a non-transitory storage medium readable by the CPU 11 as a computer, and stores the programs 131 and various data. The storage 13 includes a nonvolatile memory, such as a read only memory (ROM) or a flash memory. The programs 131 are stored in the storage 13 in the form of computer-readable program codes. The various data stored in the storage 13 include gesture setting data 132 (motion setting information) that is referred to when a gesture is made, situation data 133 and regression formula data 134.

The operation receiver 20 includes operation buttons, operation knobs and the like for, for example, turning on and off power and adjusting the volume of a sound to be output by the sound outputter 30. The operation receiver 20 outputs pieces of operation information corresponding to input operations on the operation buttons, the operation knobs and the like to the CPU 11.

The sound outputter 30 includes a speaker, and outputs a sound with a pitch, a length and a volume in accordance with a control signal(s) and sound data transmitted from the CPU 11. The sound may be a sound simulating a cry of a living creature.

The driver 40 causes the above-described twist motor 41 and vertical motion motor 42 to operate in accordance with control signals transmitted from the CPU 11.

The sensor unit 50 includes the above-described touch sensors 51, acceleration sensor 52, gyro sensor 53, illuminance sensor 54 and microphone 55, and outputs detection results by these sensors and the microphone 55 to the CPU 11. The touch sensors 51 detect touches on the robot 1 by a user or another object. Examples of the touch sensors 51 include a pressure sensor and a capacitance sensor. On the basis of detection results transmitted from the touch sensors 51, the CPU 11 determines whether contact (interaction) between the robot 1 and the user has occurred. The acceleration sensor 52 detects acceleration in each of directions of three axes perpendicular to one another. The gyro sensor 53 detects angular velocity around each of the directions of three axes perpendicular to one another. The illuminance sensor 54 detects brightness around the robot 1. The microphone 55 detects sound(s) around the robot 1 and outputs data on the detected sound to the CPU 11.

The communicator 60 is a communication module including an antenna, a modulation-and-demodulation circuit and a signal processing circuit, and performs wireless data communication with an external device(s) in accordance with a predetermined communication standard.

The power supplier 70 includes a battery 71 and a remaining quantity detector 72. The battery 71 supplies electric power to the components of the robot 1. The battery 71 of this embodiment is a secondary cell that can be repeatedly charged by a contactless charging method. The remaining quantity detector 72 detects the remaining life of the battery 71 in accordance with a control signal transmitted from the CPU 11 and outputs a detection result to the CPU 11. The remaining quantity detector 72 may be regarded as a sensor that detects the remaining life of the battery 71. Therefore, the remaining quantity detector 72 constitutes a “sensor”.

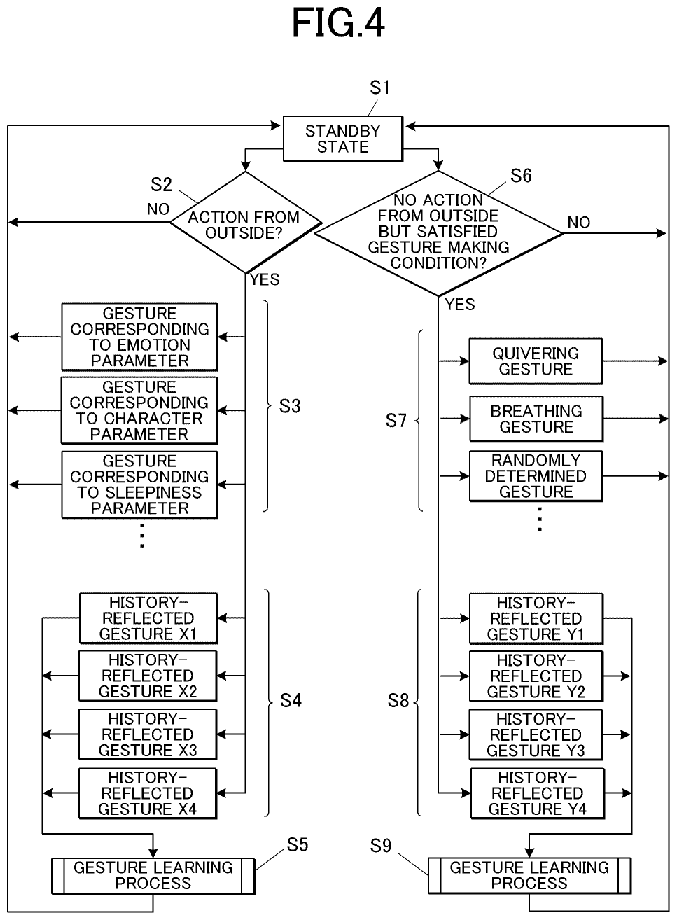

Next, the operation of the robot 1 will be described. FIG. 4 schematically illustrates transition of the operation state of the robot 1. The operation state of the robot 1 is changed under the control of the CPU 11. In a standby state (Step S1), the robot 1 is at rest without making a gesture.

If the CPU 11 determines that a predetermined external action (stimulus) has been detected in the standby state (Step S2; YES), the CPU 11 causes the robot 1 to make one of predetermined gestures at a timing at which the robot 1 looks as if it is reacting to the action (Step S3 or Step S4). In this embodiment, the external action is a touch, a hug, talking or the like by the user. Touches are detected by the touch sensors 51. Hugs are detected by at least one of the touch sensors 51, the acceleration sensor 52 and the gyro sensor 53. Talking is detected by the microphone 55. Examples of the gestures that the robot 1 makes as reactions to external actions include gestures corresponding to internal parameters of the robot 1, such as an emotion parameter, a character parameter and a sleepiness parameter (Step S3), and gestures reflecting contact history (contact records) between the robot 1 and the user, which are hereinafter referred to as “history-reflected gestures X1 to X4” (Step S4). The internal parameters are stored in the storage 13 and updated as appropriate in accordance with the environment of the robot 1, external actions and so forth.

Each gesture by the robot 1 is made in accordance with a gesture pattern PT (motion pattern) registered in the gesture setting data 132 illustrated in FIG. 5. Gesture patterns PT corresponding to all the gestures that the robot 1 makes are stored in the gesture setting data 132. Each gesture pattern PT is made up of a combination (array) of two or more motion elements. For example, in this embodiment, each gesture pattern PT is made up of a combination of six motion elements E1 to E6. The motion elements E1 to E6 are each represented by a Boolean value (“0” or “1”). Therefore, there are 2⁶ combinations, namely, 64 combinations, as gesture patterns PT.

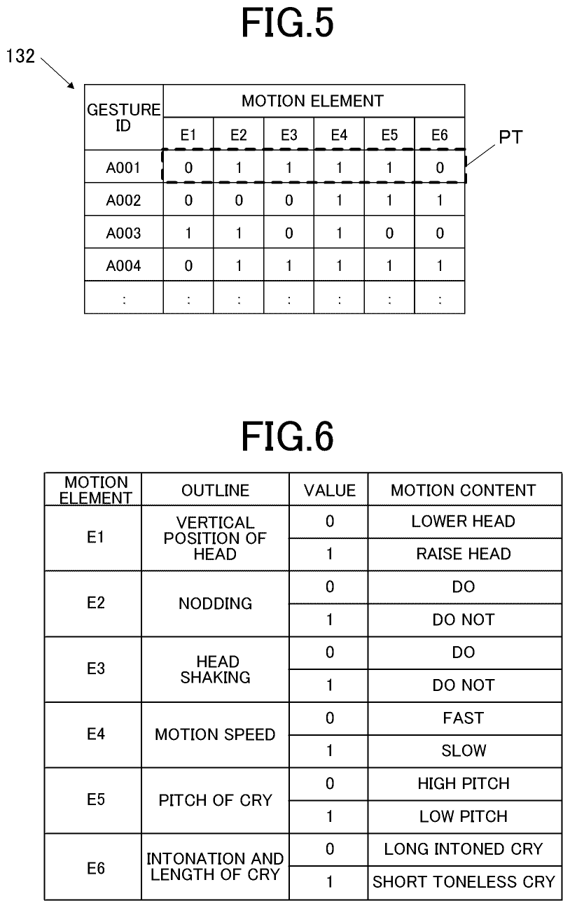

FIG. 6 illustrates the contents of the motion elements E1 to E6. The motion elements E1 to E6 each represent a motion of one part of the robot 1. The motion element E1 represents the vertical position of the head that is fixed/determined by the vertical motion motor 42. The motion element E1 represents, with a value of “0”, lowering the head, and represents, with a value of “1”, raising the head. The motion element E2 represents whether to nod (the head) with the vertical motion motor 42. The motion element E2 represents, with a value of “0”, nodding, and represents, with a value of “1”, not nodding. The motion element E3 represents whether to shake the head with the twist motor 41 and/or the vertical motion motor 42. The motion element E3 represents, with a value of “0”, shaking the head, and represents, with a value of “1”, not shaking the head. The motion element E4 represents the speed of motion (movement) of the head that is fixed/determined by the twist motor 41 and/or the vertical motion motor 42. The motion element E4 represents, with a value of “0”, moving the head at a fast motion speed, and represents, with a value of “1”, moving the head at a slow motion speed. The motion element E5 represents the pitch of a cry that is output by the sound outputter 30. The motion element E5 represents, with a value of “0”, outputting a high-pitched cry, and represents, with a value of “1”, outputting a low-pitched cry. The motion element E6 represents whether a cry that is output by the sound outputter 30 is intoned and also represents the length of the cry. The motion element E6 represents, with a value of “0”, outputting a long intoned cry, and represents, with a value of “1”, outputting a short toneless cry.

In Step S3 or Step S4 in FIG. 4, the CPU 11 selects a gesture pattern PT of a motion to make, and causes the driver 40 and the sound outputter 30 to operate such that the robot 1 moves (makes a motion) in accordance with the motion elements E1 to E6 of the selected gesture pattern PT. For example, if a gesture pattern PT having a gesture ID of “A001” illustrated in FIG. 5 is selected, the motion elements E1 to E6 are “0”, “1”, “1”, “1”, “1” and “0”, respectively, so that the CPU 11 causes the robot 1 to lower its head at a slow motion speed without nodding or shaking the head and output a long low-pitched intoned cry. In this specification, motions that the robot 1 makes in accordance with gesture patterns PT are referred to as “gestures”.

When one of the gestures in Step S3 in FIG. 4 finishes, the CPU 11 changes the operation state of the robot 1 to the standby state. On the other hand, when one of the history-reflected gestures X1 to X4, which is hereinafter referred to as a “history-reflected gesture X”, in Step S4 finishes, the CPU 11 performs a gesture learning process (Step S5).

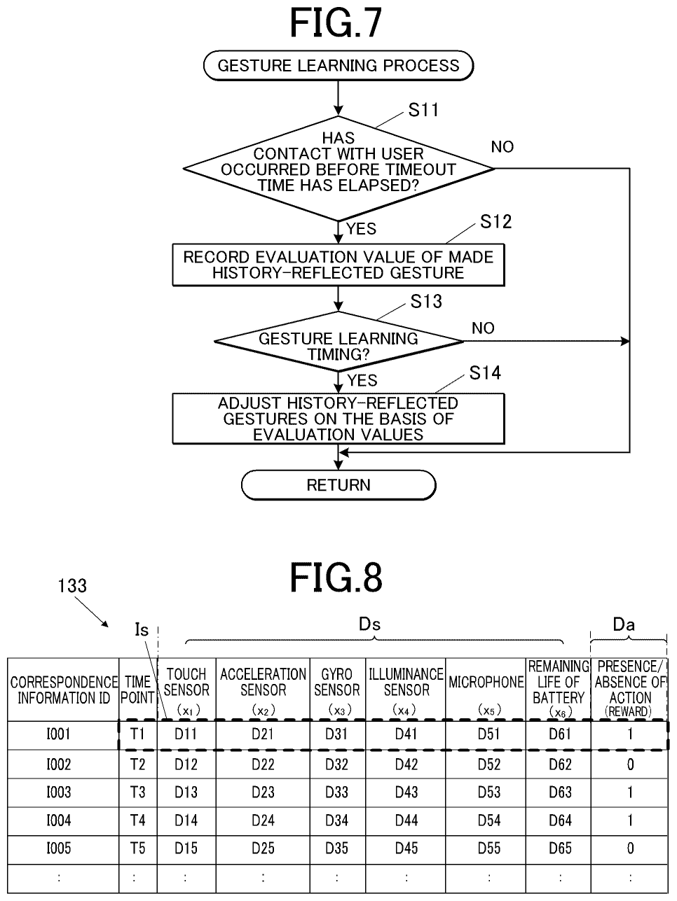

FIG. 7 is a flowchart illustrating a control procedure for the gesture learning process. When the gesture learning process is called, the CPU 11 determines whether contact between the user and the robot 1 has occurred, namely, whether the robot 1 has received an action from the user, before a predetermined timeout time (predetermined time) has elapsed from the start of the history-reflected gesture X, (Step S11). In this embodiment, when, for example, the touch sensor(s) 51 detects a touch, when the acceleration sensor 52 and/or the gyro sensor 53 detects a hug, or when the microphone 55 detects user's talking, the CPU 11 determines that the robot 1 has received an action from the user. The timeout time is preset and stored in the storage 13, and may be, for example, about ten seconds to a few tens of seconds. If the CPU 11 determines that the contact with the user has occurred before the timeout time has elapsed (Step S11; YES), the CPU 11 derives an evaluation value about the made history-reflected gesture X with a predetermined method, and records the evaluation value in the storage 13 (Step S12). For example, the evaluation value may be derived such that the shorter the length of time from when the history-reflected gesture X is made until when the contact occurs, the higher the evaluation value. If the CPU 11 determines that the contact with the user has not occurred before the timeout time has elapsed (Step S11; NO), the CPU 11 ends the gesture learning process without recording an evaluation value about the made history-reflected gesture X (or after recording an evaluation value of “0”).

After recording the evaluation value in Step S12, the CPU 11 determines whether it is a timing to learn gestures, which is hereinafter referred to as a “gesture learning timing” (Step S13). For example, the CPU 11 may determine that it is a gesture learning timing if evaluation values about all the history-reflected gestures X1 to X4 have been recorded at least once. If the CPU 11 determines that it is a gesture learning timing (Step S13; YES), the CPU 11 adjusts (changes) the contents of the history-reflected gestures X1 to X4 on the basis of the recorded evaluation values and updates the gesture setting data 132 to the adjusted contents (Step S14). In this embodiment, the CPU 11 performs, for each of the history-reflected gestures X1 to X4, a process of changing at least one of the motion elements E1 to E6. For example, the CPU 11 may randomly extract motion elements of two gestures that have higher evaluation values among the history-reflected gestures X1 to X4, and combine the extracted motion elements to generate four new history-reflected gestures X1 to X4. By the changing process in Step S14, the robot 1 learns the new history-reflected gestures X1 to X4. By repeating this learning, the (original) history-reflected gestures X1 to X4 converge to user's preferred gestures. After Step S14 or if the CPU 11 determines that it is not a gesture learning timing (Step S13; NO), the CPU 11 ends the gesture learning process, and changes the operation state of the robot 1 to the standby state in FIG. 4 (Step S1).

In the standby state in FIG. 4 (Step S1), if the CPU 11 determines that no predetermined external action has been detected but a predetermined gesture making condition is satisfied (Step S6; YES), the CPU 11 causes the robot 1 to make one of predetermined spontaneous gestures, which the robot 1 makes spontaneously (Step S7 or Step S8). The gesture making condition will be described later. Examples of the spontaneous gestures include a quivering gesture, a breathing gesture and a randomly determined gesture (Step S7) and gestures reflecting contact history (contact records) between the robot 1 and the user, which are hereinafter referred to as “history-reflected gestures Y1 to Y4” (Step S8). When one of the gestures in Step S7 finishes, the CPU 11 changes the operation state of the robot 1 to the standby state. On the other hand, when one of the history-reflected gestures Y1 to Y4, which is hereinafter referred to as a “history-reflected gesture Y”, in Step S8 finishes, the CPU 11 performs a gesture learning process (Step S9). The gesture learning process in Step S9 is the same as that in Step S5 described above with reference to FIG. 7 except that the “history-reflected gestures X1 to X4” are replaced with the “history-reflected gestures Y1 to Y4”, and the “history-reflected gesture X” is replaced with the “history-reflected gesture Y”. After ending the gesture learning process, the CPU 11 changes the operation state of the robot 1 to the standby state (Step S1).

The robot 1 of this embodiment spontaneously makes a gesture in the absence of an external action, as in Step S6 to Step S8. However, if the robot 1 makes one of the history-reflected gestures Y1 to Y4 while the user is not nearby, no contact with the user (no action from the user) occurs in response to the gesture, and accordingly the evaluation value derived in Step S12 of the gesture learning process is “0”, which decreases the learning efficiency of gestures. Since the robot 1 is not provided with either a camera or a motion sensor, whether the user is near the robot 1 and aware of (e.g., paying attention to) the robot 1 cannot be determined with a camera or a motion sensor.

Therefore, the robot 1 of this embodiment repeatedly derives the probability of receiving an action from the user with a predetermined method, and makes a spontaneous gesture at a timing at which the derived probability is equal to or more than a predetermined threshold value. That is, if the derived probability is equal to or more than the threshold value, the CPU 11 determines that the gesture making condition in Step S6 in FIG. 4 is satisfied, and causes the robot 1 to make a gesture in Step S7 or Step S8. The derived probability being high indicates that the user is highly likely to be near the robot 1 and aware of the robot 1. Thus, the method of this embodiment enables the robot 1 to make any of the history-reflected gestures Y1 to Y4 in the situation in which the robot 1 can appropriately receive an action from the user.

In order to derive the probability of receiving an action from the user, the CPU 11 generates the situation data 133 illustrated in FIG. 8. The situation data 133 includes pieces of correspondence information Is corresponding to points in time (e.g., “T1” to “T5” in FIG. 8), which are hereinafter referred to as “time points”, different from one another. Each piece of correspondence information Is is a piece of information in which sensor data Ds is correlated with action data Da. The sensor data Ds includes data on detection results by the respective sensors of the sensor unit 50 (touch sensors 51, acceleration sensor 52, gyro sensor 53, illuminance sensor 54 and microphone 55) and data on the remaining life of the battery 71 detected by the remaining quantity detector 72 at a time point, which is hereinafter referred to as a “certain time point”. The action data Da is data that indicates whether the robot 1 has received a predetermined action from the outside (user) within a predetermined period including the time point at which the sensor data Ds was detected (generated), namely, the certain time point. The action data Da is “1” if the robot 1 receives an action, or “0” if the robot 1 receives no action. The action data Da is equivalent to a reward in unsupervised learning that the robot 1 does.

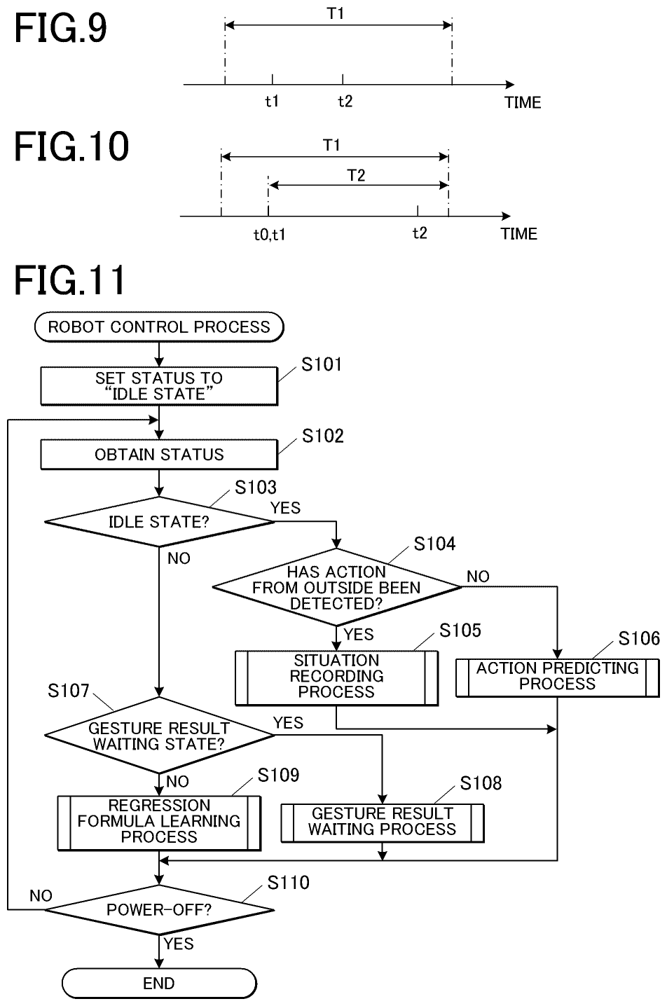

The CPU 11 performs, for each time point, a process of generating a piece of correspondence information Is by correlating sensor data Ds with action data Da and storing the generated piece of correspondence information Is, thereby generating the situation data 133 including pieces of correspondence information Is corresponding to time points. For example, if the CPU 11 determines that the robot 1 has received a predetermined action from the user, the CPU 11 generates a piece of correspondence information Is in which sensor data Ds at a certain time point corresponding to a time point at which the robot 1 received the action is correlated with a reward of “1” as action data Da, and records the generated piece of correspondence information Is in the situation data 133. The time point at which the robot 1 received an action and the time point at which sensor data Ds was generated may not coincide. For example, as illustrated in FIG. 9, the CPU 11 may generate a piece of correspondence information Is by correlating sensor data Ds at a certain time point t1 with action data Da indicating whether the robot 1 has received an external action (e.g., a reward of “1”) at a time point t2 in a predetermined period T1 including the time point t1. The predetermined period T1 may include a period before the time point t1, and/or may include a period after the time point t2. Further, in FIG. 9, the time point t1 is before the time point t2, but not limited thereto and therefore may be after the time point t2. The length of the predetermined period T1 may be about a few seconds to a few tens of seconds.

When the CPU 11 causes the robot 1 to make one of the history-reflected gestures Y1 to Y4 spontaneously, the CPU 11 generates a piece of correspondence information Is as follows. That is, as illustrated in FIG. 10, if the CPU 11 determines that the robot 1 has received an action from the user at a time point t2 in a timeout time T2 starting from a time point t0 at which the robot 1 started to make one of the history-reflected gestures Y1 to Y4, the CPU 11 generates a piece of correspondence information Is in which sensor data Ds at a certain time point t1 corresponding to the time point t0 is correlated with a reward of “1” as action data Da, and records the generated piece of correspondence information Is in the situation data 133. On the other hand, if the CPU 11 determines that the robot 1 has received no action from the user within the timeout time T2 starting from the time point t0, the CPU 11 generates a piece of correspondence information Is in which the sensor data Ds at the certain time point t1 corresponding to the time point t0 is correlated with a reward of “0” as action data Da, and records the generated piece of correspondence information Is in the situation data 133. The time point t1 may be the same as (coincide with) or different from the time point t0. The time point t1 may be before or after the time point t0. The predetermined period T1 is set to include the time point t0 and also include the timeout time T2 starting from the time point t0. The aforementioned time points corresponding to pieces of correspondence information Is are each a representative time point within the predetermined period T1, and may be the same as (coincide with) or different from the time point t0, the time point t1 or the time point t2 illustrated in FIG. 9 or FIG. 10

When the CPU 11 causes the robot 1 to make one of the history-reflected gestures X1 to X4 as a reaction to an action from the user, the CPU 11 may not generate (and accordingly not record in the situation data 133) a piece of correspondence information Is on whether the robot 1 has received an action within the timeout time T2 from the start of the gesture. This is because it is not always appropriate to use presence/absence of actions in response to the history-reflected gestures X1 to X4 in deriving the probability for the robot 1 to timely make the history-reflected gestures Y1 to Y4, which the robot 1 makes spontaneously.

The situation data 133 illustrated in FIG. 8 may be rephrased as data that indicates the likelihood of receiving an action from the user according to the contents of sensor data Ds. That is, it can be presumed, on the basis of the situation data 133, with what values of sensor data Ds, the robot 1 is likely to receive an action, and also it can be presumed, on the basis of the situation data 133, with what values of sensor data Ds, the robot 1 is unlikely to receive an action. In this embodiment, the CPU 11 performs logistic regression analysis (predetermined regression analysis) on the basis of a plurality of pieces of correspondence information Is in the situation data 133, thereby deriving a regression formula for the probability that the robot 1 receives an action. The logistic regression analysis is one of multivariate analysis methods for predicting the probability of occurrence of a binary response variable (dependent variable) from a plurality of explanatory variables (independent variables).

More specifically, the CPU 11 performs the logistic regression analysis using the action data Da of each of pieces of correspondence information Is as the response variable and the detection results included in the sensor data Ds correlated with the action data Da as the explanatory variables, thereby deriving the following formula (1) for the probability P that the robot 1 receives an action.

$$P = 1 / \{ 1 + exp ( - A ) \} \qquad ( 1 )$$

In the formula (1), “A=β₀+β₁x₁+β₂x₂+β₃x₃+β₄x₄+β₅x₅+β₆x₆”.

The “x₁” to “x₆” are the explanatory variables. The explanatory variable x₁ is a detection result of a touch by the touch sensor(s) 51. The explanatory variable x₂ is a detection result of the acceleration by the acceleration sensor 52. The explanatory variable x₃ is a detection result of the angular velocity by the gyro sensor 53. The explanatory variable x₄ is a detection result of the illuminance (brightness) by the illuminance sensor 54. The explanatory variable x₅ is a detection result of a sound by the microphone 55. The explanatory variable x₆ is a detection result of the remaining life of the battery 71 by the remaining quantity detector 72. The “β₁” to “β₆” are regression variables representing magnitudes (weights) of influence that the explanatory variables exert on the probability P, and the “β₀” is a regression variable that gives the intercept (bias). The process of deriving the regression formula (1) may be rephrased as a process of deriving the regression variables β₀ to β₆. The derived regression variables β₀ to β₆ are stored in the regression formula data 134 of the storage 13.

The CPU 11 derives the regression formula (1) first time when a predetermined minimum number of pieces of correspondence information Is are stored in the situation data 133. In this embodiment, the minimum number is “5”, but not limited thereto and therefore may be changed as appropriate according to, for example, a required deriving accuracy of the probability P. After deriving the regression formula (1) first time, each time the CPU 11 stores a new piece of correspondence information Is in the situation data 133 of the storage 13, the CPU 11 derives the regression formula (1) on the basis of a plurality of pieces of correspondence information Is including the newest (most recently stored) piece of correspondence information Is to update the regression variables β₀ to β₆ of the regression formula data 134. Alternatively, for example, each time the CPU 11 stores a certain number of new pieces of correspondence information Is, the certain number being two or more, the CPU 11 may derive the regression formula (1) to update the regression variables β₀ to β₆. The process of deriving the regression formula (1) at each timing uses all the pieces of correspondence information Is recorded in the situation data 133 at the timing. The maximum number of pieces of correspondence information Is to be recorded in the situation data 133 may be set according to, for example, the storage capacity of the storage 13. If the CPU 11 newly generates a piece of correspondence information Is in a situation in which the maximum number of pieces of correspondence information Is are recorded in the situation data 133, the CPU 11 overwrites the oldest piece of correspondence information Is in the situation data 133 with the newest (newly generated) piece of correspondence information Is. In this embodiment, the maximum number is “60”. Adjusting the maximum number can adjust how far into the past the robot 1 learns gestures made.

After deriving the regression formula (1), the CPU 11 obtains sensor data Ds at a time point corresponding to a specific time point at which presence or absence of an action from the user is desired to be predicted, and assigns the obtained sensor data Ds to the explanatory variables x₁ to x₆ of the regression formula (1), thereby deriving, in percentage, the probability P of receiving an action from the user at the specific time point. The specific time point may be different from the time points corresponding to the respective pieces of correspondence information Is. As described above, the robot 1 makes one of the history-reflected gestures Y1 to Y4 at a time point at which the derived probability P is equal to or more than a predetermined threshold value. Thus, the robot 1 can make any of the history-reflected gestures Y1 to Y4 at a time point at which the user is likely to be near the robot 1 and the robot 1 is likely to receive an action from the user.

Next, the robot control process that is performed by the CPU 11 to realize the above-described operation will be described. FIG. 11 is a flowchart illustrating a control procedure for the robot control process. The robot control process starts when the robot 1 is powered on. When the robot control process starts, the CPU 11 sets the status of the robot 1 to the “Idle State” (Step S101). That is, the CPU 11 rewrites the status data 121 in the RAM 12 to a value corresponding to the “Idle State”.

The CPU 11 refers to the status data 121 to obtain the current status of the robot 1 (Step S102). If the CPU 11 determines that the status of the robot 1 is the “Idle State” (Step S103; YES), the CPU 11 determines on the basis of sensor data Ds obtained from the sensor unit 50 whether an action from the outside (user), namely, an external action, has been detected (Step S104). For example, the CPU 11 determines that an external action has been received when the touch sensor(s) 51 detects a user's touch, when the acceleration sensor 52 and/or the gyro sensor 53 detects a hug, or when the microphone 55 detects user's talking. If the CPU 11 determines that an external action has been detected (received) (Step S104; YES), the CPU 11 performs a situation recording process for recording a piece of correspondence information Is corresponding to the action (Step S105).

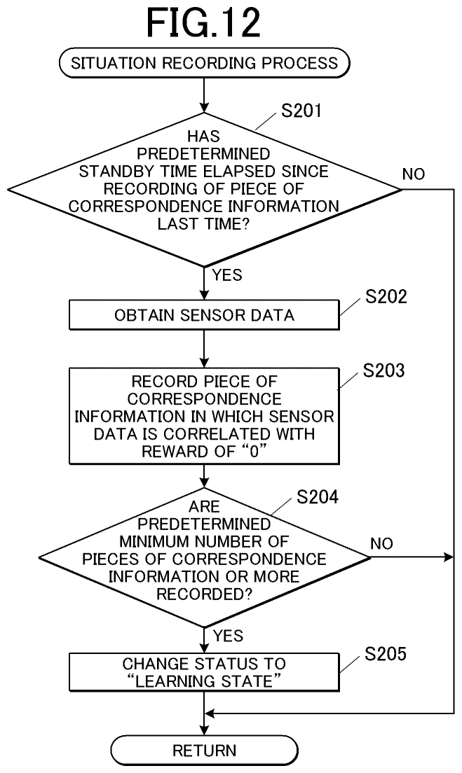

FIG. 12 is a flowchart illustrating a control procedure for the situation recording process. When the situation recording process is called, the CPU 11 determines whether a predetermined standby time has elapsed since recording of a piece of correspondence information Is last time (Step S201). This is because recording of pieces of correspondence information Is at timings close to one another at which sensor data Ds similar to one another are obtained does not lead to improvement of the accuracy of the regression formula (1). Therefore, the standby time is set to a length of time in which a certain amount of change or more may occur in the situation of the surroundings of the robot 1, and may be set to, for example, about one minute to ten minutes. If the CPU 11 determines that the predetermined standby time has elapsed since recording of a piece of correspondence information Is last time (Step S201; YES), the CPU 11 obtains sensor data Ds from the components of the sensor unit 50 and the remaining quantity detector 72 at a time point t1 corresponding to a time point t2 at which the external action in Step S104 in FIG. 11 was received (Step S202). The CPU 11 records, in the situation data 133, a piece of correspondence information Is in which the obtained sensor data Ds is correlated with a reward of “1” as action data Da (Step S203).

The CPU 11 determines whether a predetermined minimum number of pieces of correspondence information Is (“5” in this embodiment) or more are recorded in the situation data 133 (Step S204). If the CPU 11 determines that the minimum number of pieces of correspondence information Is or more are recorded (Step S204; YES), the CPU 11 changes the status of the robot 1 to the “Learning State” (Step S205). That is, the CPU 11 rewrites the status data 121 to a value corresponding to the “Learning State”. After Step S205, Step S201; NO or Step S204; NO, the CPU 11 ends the situation recording process, and returns the process to the robot control process illustrated in FIG. 11.

In Step S104 in FIG. 11, if the CPU 11 determines that no external action has been detected (Step S104; NO), the CPU 11 performs an action predicting process for predicting presence or absence of an action from the user on the basis of the situation at the time (Step S106).

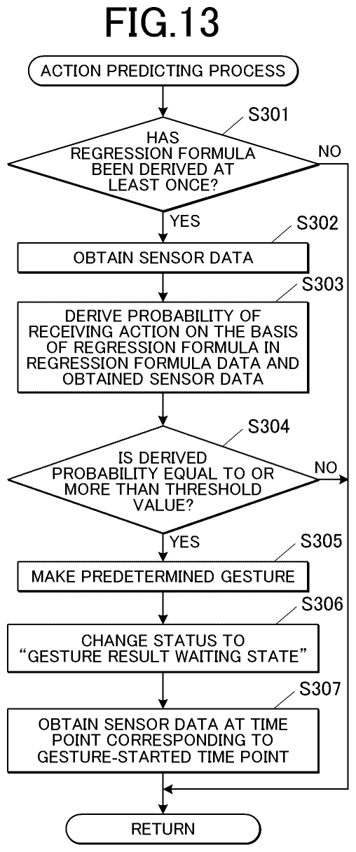

FIG. 13 is a flowchart illustrating a control procedure for the action predicting process. When the action predicting process is called, the CPU 11 determines whether the regression formula (1) has been derived at least once (Step S301). If the CPU 11 determines that the regression formula (1) has been derived at least once (Step S301; YES), the CPU 11 obtains sensor data Ds from the components of the sensor unit 50 and the remaining quantity detector 72 (Step S302). The sensor data Ds obtained in Step S302 correspond to “detection results by the sensors at a time point corresponding to the specific time point”. The CPU 11 derives the probability P of receiving an external action on the basis of the regression formula (1) and the obtained sensor data Ds (Step S303). That is, the CPU 11 derives the probability P by assigning (substituting) the explanatory variables x₁ to x₆ of the sensor data Ds to (into) the regression formula (1) expressed with the regression variables β₀ to β₆ recorded in the regression formula data 134.

The CPU 11 determines whether the derived probability P is equal to or more than a predetermined threshold value (Step S304). If the CPU 11 determines that the probability P is equal to or more than the threshold value (Step S304; YES), the CPU 11 determines that the gesture making condition is satisfied, and causes the robot 1 to make a predetermined gesture (in this embodiment, one of the history-reflected gestures Y1 to Y4) (Step S305). Step S304; YES corresponds to Step S6; YES in FIG. 4. The gesture making condition may include another requirement(s) in addition to the probability P being equal to or more than the threshold value. Examples of the additional requirement include a requirement that a predetermined (length of) time has elapsed since a gesture was made last time, a requirement that the brightness around the robot 1 is at a predetermined level or more, a requirement that it is a predetermined time, a requirement that the remaining life of the battery 71 is less than a predetermined value, and any combinations of these.

After Step S305, the CPU 11 changes the status of the robot 1 to the “Gesture Result Waiting State” (Step S306). That is, the CPU 11 rewrites the status data 121 to a value corresponding to the “Gesture Result Waiting State”. The CPU 11 obtains sensor data Ds from the components of the sensor unit 50 and the remaining quantity detector 72 at a time point t1 corresponding to a time point t0 (gesture-started time point) at which the robot 1 started to make the gesture in Step S305 (Step S307). The sensor data Ds obtained in Step S307 is used to generate a piece of correspondence information Is in a gesture result waiting process described later. After Step S307, Step S301; NO or S304; NO, the CPU 11 ends the action predicting process, and returns the process to the robot control process illustrated in FIG. 11.

In Step S103 in FIG. 11, if the CPU 11 determines that the status of the robot 1 is not the “Idle State” (Step S103; NO), the CPU 11 determines whether the status of the robot 1 is the “Gesture Result Waiting State” (Step S107). If the CPU 11 determines that the status of the robot 1 is the “Gesture Result Waiting State” (Step S107; YES), the CPU 11 performs the gesture result waiting process (Step S108).

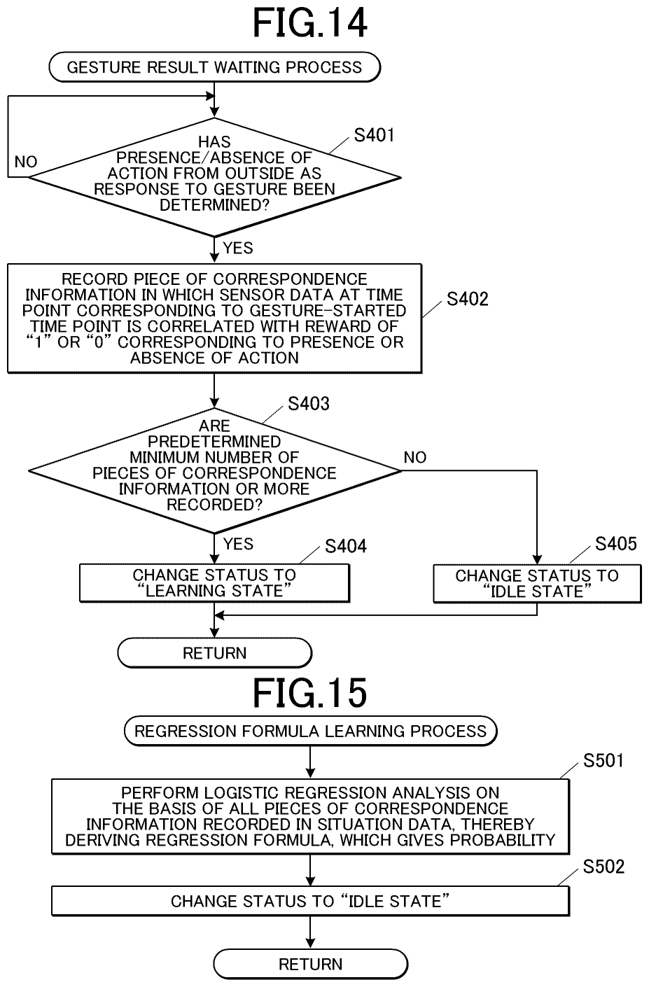

FIG. 14 is a flowchart illustrating a control procedure for the gesture result waiting process. When the gesture result waiting process is called, the CPU 11 repeatedly determines whether an action from the outside (user), namely, an external action, as a response to the gesture made in Step S305 of the action predicting process illustrated in FIG. 13 has been received, until the CPU 11 can determine that an action is either present (has been received) or absent (has not been received) (Step S401). In this embodiment, the CPU 11 determines that an action is present if an external action is received before the timeout time T2 starting from the time point t0 at which the robot 1 started to make the gesture elapses, whereas the CPU 11 determines that an action is absent if no external action is received before the timeout time T2 elapses. The method of determining whether an external action has been received is the same as the process in Step S104 in FIG. 11.

If the CPU 11 determines that an external action as a response to the gesture is either present or absent (Step S401; YES), the CPU 11 records, in the situation data 133, a piece of correspondence information Is in which the sensor data Ds at the time point t1 corresponding to the time point t0 at which the robot 1 started to make the gesture, namely, the sensor data Ds obtained in Step S307 in FIG. 13, is correlated with, as action data Da, a reward of “1” corresponding to presence of an action or a reward of “0” corresponding to absence of an action (Step S402).

The CPU 11 determines whether the predetermined minimum number of pieces of correspondence information Is or more are recorded in the situation data 133 (Step S403). If the CPU 11 determines that the minimum number of pieces of correspondence information Is or more are recorded (Step S403; YES), the CPU 11 changes the status of the robot 1 to the “Learning State” (Step S404). If the CPU 11 determines that the number of pieces of correspondence information Is recorded is less than the minimum number (Step S403; NO), the CPU 11 changes the status of the robot 1 to the “Idle State” (Step S405). After Step S404 or Step S405, the CPU 11 ends the gesture result waiting process, and returns the process to the robot control process illustrated in FIG. 11.

In the robot control process illustrated in FIG. 11, if the CPU 11 determines that the status of the robot 1 is neither the “Idle State” (Step S103; NO) nor the “Gesture Result Waiting State” (Step S107; NO), the CPU 11 determines that the status of the robot 1 is the “Learning State” and performs a regression formula learning process (Step S109).

FIG. 15 is a flowchart illustrating a control procedure for the regression formula learning process. When the regression formula learning process is called, the CPU 11 performs the logistic regression analysis on the basis of all the pieces of correspondence information Is recorded in the situation data 133, thereby deriving the regression formula (1), which gives the probability P (Step S501). The CPU 11 records, in the regression formula data 134, the values of β₀ to β₆ of the regression formula (1) derived. If β₀ to β₆ are already recorded in the regression formula data 134, the CPU 11 overwrites/updates them with/to the newest β₀ to β₆ currently derived. Then, the CPU 11 changes the status of the robot 1 to the “Idle State” (Step S502). Thereafter, the CPU 11 ends the regression formula learning process, and returns the process to the robot control process illustrated in FIG. 11. Depending on the processing capability of the CPU 11 or the like, the CPU 11 may divide the process of deriving the regression formula (1) in Step S501 into processes of multiple times. That is, the CPU 11 may perform the regression formula learning process multiple times, skipping Step S502 and keeping the status as the “Learning State” until the CPU 11 completes the deriving process divided into processes of multiple times.

In the robot control process illustrated in FIG. 11, after Step S105, Step S106, Step S108 or Step S109, the CPU 11 determines whether an operation to turn off the power of the robot 1 has been made (Step S110). If the CPU 11 determines that the operation has not been made (Step S110; NO), the CPU 11 returns the process to Step S102. If the CPU 11 determines that the operation has been made (Step S110; YES), the CPU 11 ends the robot control process.

As described above, the robot control device 10 as the information processing device of this embodiment includes the CPU 11 as a processor. The CPU 11 stores, in the storage 13, a piece of correspondence information Is in which sensor data Ds as a detection result(s) by a component(s) of the sensor unit 50 and the remaining quantity detector 72 at a certain time point t1, the sensor unit 50 and the remaining quantity detector 72 being included in the robot 1 for detecting actions (at least one action) from a user, is correlated with action data Da indicating presence or absence of a predetermined action from outside to the robot 1 within a predetermined period T1 including the certain time point t1. Based on pieces of correspondence information Is stored in the storage 13 and corresponding to time points different from one another, the CPU 11 makes a prediction for an action that the robot 1 receives from the user at a specific time point after the time points. This enables the robot 1 to make a prediction for an action from the outside on itself (e.g., to predict whether the robot 1 has received an action from the outside) using the sensor unit 50 and the remaining quantity detector 72 that the robot 1 has. Therefore, even a robot with a simple configuration not having either a camera or a motion sensor, such as the robot 1, can make a prediction for an action on itself.

Further, based on the pieces of correspondence information Is and sensor data Ds at a time point corresponding to the specific time point, the CPU 11 makes the prediction for the action that the robot 1 receives from the user at the specific time point. This makes it possible to appropriately make a prediction for an action at a specific time point on the basis of the environment of the robot 1 at a time point corresponding to the specific time point.

Further, the CPU 11 determines based on the sensor data Ds whether the robot 1 has received the action from the outside, and in response to determining that the robot 1 has received the action, stores, in the storage 13, the piece of correspondence information Is in which, as action data Da, a reward of “1” indicating that the robot 1 has received the action is correlated with the sensor data Ds at the certain time point t1 in the predetermined period T1 including a time point T2 at which the robot 1 received the action. This piece of correspondence information Is indicates when what kind of sensor data Ds, namely, what value(s) of a detection result(s) included in sensor data Ds, is obtained, an action from the outside is likely to be received. By using this kind of correspondence information Is, the probability P of receiving an action from the outside can be derived.

Further, based on the pieces of correspondence information Is corresponding to the time points, the CPU 11 predicts the probability that the robot 1 receives the action from the user at the specific time point. The derived probability P being high is equivalent to a high probability that the user is near the robot 1 and aware of the robot 1. Therefore, by causing the robot 1 to make a gesture at a timing in accordance with the probability P, the robot 1 can effectively appeal to the user and get the user to evaluate the gesture for sure.

Further, the CPU 11 causes the robot 1 to make a predetermined gesture in response to the probability P derived being equal to or more than a predetermined threshold value. This enables the robot 1 to make a gesture at a timing at which the user is highly likely to be aware of the robot 1, and therefore enables the robot 1 to effectively appeal to the user and get the user to evaluate the gesture. Further, this can produce the robot 1 that reproduces conditioned reflexes of a living creature. For example, if the user repeats stroking the robot 1 after ringing a bell, the robot 1 determines at the time of detecting the sound of the bell that the probability P of receiving an action from (of being stroked by) the user is high (equal to or more than a threshold value). By causing the robot 1 to make a cry or a gesture expressing happiness at the time point at which the probability P is high, the robot 1 can be made to look as if it is expecting to be stroked as a conditioned reflex in response to the ring of the bell.

Further, the CPU 11 stores, in the storage 13, the piece of correspondence information Is in which the sensor data Ds at the certain time point t1 corresponding to a time point t0 at which the robot started to make the gesture is correlated with the action data Da indicating the presence or absence of the action from the outside to the robot 1 within, of the predetermined period T1, a predetermined timeout time T2 from the start of the gesture. This piece of correspondence information Is indicates when what kind of sensor data Ds, namely, what value(s) of a detection result(s) included in sensor data Ds, is obtained, an action from the outside is likely to be received in response to a gesture made, and also indicates when what kind of sensor data Ds is obtained, an action from the outside is unlikely to be received in response to a gesture made. By using this kind of correspondence information Is, the probability P of receiving an action can be derived with a high accuracy on the basis of both the likelihood and the unlikelihood of receiving an action.

Further, the CPU 11 derives an evaluation value of the gesture based on the presence or absence of the action from the outside to the robot 1 within the predetermined timeout time T2 from the start of the gesture, and based on the derived evaluation value, adjusts the contents of the gesture. This enables the robot 1 to learn user's preferred gestures on the basis of actions from the user received as responses to gestures made by the robot 1. Further, by causing the robot 1 to make a spontaneous gesture at a timing at which the probability P is equal to or more than a threshold value, the problem is prevented from occurring that the evaluation value of a gesture is low due to the user not near the robot 1 or aware of the robot 1 at the time when the robot 1 makes the gesture. Therefore, appropriate advancement of learning of user's preferred gestures, namely, appropriate convergence of gestures to user's preferred gestures, can be performed. In other words, divergence of gesture learning due to inappropriate evaluation of gestures is prevented.

Further, the CPU 11 performs the logistic regression analysis using, as explanatory variables, detection results included in sensor data Ds of each of the pieces of correspondence information Is, thereby deriving the regression formula (1) for the probability P that the robot 1 receives the action, and derives the probability P based on the derived regression formula (1) and detection results included in sensor data Ds at a time point corresponding to the specific time point. The regression formula (1) can identify how much each detection result of sensor data Ds affects the probability P. Thus, the probability P can be derived with a high accuracy by the simple process of assigning (substituting) detection results of sensor data Ds at a time point to (into) the regression formula (1). Further, since the probability P can be output as a percentage, a clear process in accordance with the value of the probability P (e.g., determination on branching in a flow) can be performed.

Further, the CPU 11 derives the regression formula (1) in response to a predetermined minimum number of pieces of correspondence information Is or more being stored in the storage 13, and after deriving the regression formula (1), each time the CPU 11 stores a piece of correspondence information Is in the storage 13, updates the regression formula (1) based on a plurality of pieces of correspondence information stored in the storage 13 including the piece of correspondence information Is most recently stored. This can improve the accuracy of deriving the probability P as the cumulative operation time of the robot 1 increases.

Further, the robot 1 of this embodiment includes the robot control device 10 and the components of the sensor unit 50 and the remaining quantity detector 72 as a plurality of sensors. This enables the robot 1, which has a simple configuration, to predict presence or absence of an action from the outside to the robot 1. Further, since the probability P can be derived inside the robot 1 in real time, it is unnecessary to transmit data for deriving the probability P to the outside and to perform processes for data encryption and data transmission.

Further, the information processing method that is performed by the CPU 11 includes storing, in the storage 13, a piece of correspondence information Is in which sensor data Ds at a certain time point t1 is correlated with action data Da indicating presence or absence of a predetermined action from outside to the robot 1 within a predetermined period T1 including the certain time point t1, and based on pieces of correspondence information Is stored in the storage 13 and corresponding to time points different from one another, making a prediction for an action that the robot 1 receives from the user at a specific time point after the time points. Further, the storage 13 as the non-transitory computer-readable storage medium of this embodiment stores the program(s) 131. The program 131 causes the CPU 11 to function as a processor that performs the above-described information processing method. These each enable the robot 1, which has a simple configuration, to make a prediction for an action from the outside on itself. Further, by causing the robot 1 to make a gesture at a timing in accordance with the probability P, the robot 1 can effectively appeal to the user and get the user to evaluate the gesture.

The present disclosure is not limited to the above-described embodiment, but can be modified in a variety of aspects. For example, in the above embodiment, detection of user's contact (touch, hug or talking) (Step S104 in FIG. 11, Step S401 in FIG. 14) is used as a trigger for generating and recording a piece of correspondence information Is, but the trigger is not limited thereto. By changing the trigger for generating a piece of correspondence information Is, a timing at which a desired event occurs can be predicted. For example, by generating and recording a piece of correspondence information Is at a timing at which the robot 1 was thrown up by the user (or at a timing at which the robot 1 was not thrown up), the probability that the robot 1 is thrown up by the user can be predicted. This enables the robot 1 to make a gesture expressing unpleasantness just before the timing at which the user may throw up the robot 1. By using, instead of the user's throwing-up, another action from the user (hug, talking, swinging, start of charging of the robot 1, end of charging of the robot 1, etc.) as the trigger, the probability that the action occurs can be predicted.

Further, by subtracting the derived probability from “1”, the probability that an action from the user does not occur can be predicted. By using this probability, the robot 1 can, for example, reduce the amount of activity in a period during which the probability that user's contact occurs is low. In response to no action being received from the user, a reward of “1” may be recorded as action data Da. Thus, the probability of not receiving an action at a specific time point can be derived with the regression formula (1).

Further, the method of deriving the probability that the robot 1 receives an action is not limited to the logistic regression analysis. As the predetermined regression analysis, regression analysis other than the logistic regression analysis may be used. Further, analysis other than regression analysis may be used. For example, on the basis of pieces of correspondence information Is, the CPU 11 may identify, in their sensor data Ds, a data item (one of x₁ to x₆) having the greatest correlation with “1” and “0” of the action data Da using a predetermined correlation analysis method, and derive the probability according to the size of the data item. For example, if positive correlation is present between the data item and the action data Da, the CPU 11 may derive a higher probability as the data item is larger, whereas if negative correlation is present between the data item and the action data Da, the CPU 11 may derive a lower probability as the data item is larger.

Further, the CPU 11 may make, on the basis of only the pieces of correspondence information Is stored in the storage 13 and corresponding to time points, a prediction for an action that the robot 1 receives from the user at a specific time point after the time points. For example, the CPU 11 may predict, on the basis of chronological change in the sensor data Ds of the pieces of correspondence information Is corresponding to time points and chronological change in the action data Da thereof, presence or absence of an action to the robot 1 at a desired time point after the time points, the probability of receiving (or not receiving) an action, or the like.

Further, the configuration of the robot 1 is not limited to the one illustrated in FIG. 1 to FIG. 3. For example, the robot 1 may be a robot made to simulate an existing living creature, such as a human, an animal, a bird or a fish, a robot made to simulate a no-more-existing living creature, such as a dinosaur, or a robot made to simulate an imaginary living creature.

Further, in the above embodiment, the robot control device 10 as the information processing device is disposed inside the robot 1, but not limited thereto. The information processing device may be disposed outside the robot 1. This externally disposed information processing device performs the functions that the robot control device 10 of the above embodiment performs. In this case, the robot 1 operates in accordance with control signals received from the externally disposed information processing device via the communicator 60. The externally disposed information processing device may be a smartphone, a tablet terminal or a notebook PC, for example.

Further, in the above embodiment, the flash memory of the storage 13 is used as the computer-readable medium storing the programs of the present disclosure, but the computer-readable medium is not limited thereto. As the computer-readable medium, an information storage/recording medium, such as a hard disk drive (HDD), a solid state drive (SSD) or a CD-ROM, is also applicable. Further, a carrier wave is applicable as a medium that provides data of the programs of the present disclosure via a communication line.

Further, it goes without saying that the detailed configuration and detailed operation of each component of the robot 1 in the above embodiment can be modified as appropriate without departing from the scope of the present disclosure.

Although one or more embodiments of the present disclosure have been described above, the scope of the present disclosure is not limited to the embodiments above, but includes the scope of claims below and the scope of their equivalents.

1. An information processing device comprising a processor that
stores, in a storage, a piece of correspondence information in which a detection result by a sensor at a certain time point, the sensor being included in a robot for detecting at least one action from a user, is correlated with presence or absence of a predetermined action from outside to the robot within a predetermined period including the certain time point, and
based on pieces of correspondence information stored in the storage and corresponding to time points different from one another, the pieces of correspondence information each being the piece of correspondence information, makes a prediction for an action that the robot receives from the user at a specific time point after the time points.

2. The information processing device according to claim 1, wherein based on the pieces of correspondence information and a detection result by the sensor at a time point corresponding to the specific time point, the processor makes the prediction for the action that the robot receives from the user at the specific time point.

3. The information processing device according to claim 1, wherein the processor
determines based on the detection result by the sensor whether the robot has received the action from the outside, and
in response to determining that the robot has received the action, stores, in the storage, the piece of correspondence information in which information indicating that the robot has received the action is correlated with the detection result by the sensor at the certain time point in the predetermined period including a time point at which the robot received the action.

4. The information processing device according to claim 1, wherein based on the pieces of correspondence information corresponding to the time points, the processor predicts a probability that the robot receives the action from the user at the specific time point.

5. The information processing device according to claim 4, wherein the processor causes the robot to make a predetermined motion in response to the probability derived being equal to or more than a predetermined threshold value.

6. The information processing device according to claim 5, wherein the processor stores, in the storage, the piece of correspondence information in which the detection result by the sensor at the certain time point corresponding to a time point at which the robot started to make the motion is correlated with the presence or absence of the action from the outside to the robot within, of the predetermined period, a predetermined time from the start of the motion.

7. The information processing device according to claim 6, wherein the processor
derives an evaluation value of the motion based on the presence or absence of the action from the outside to the robot within the predetermined time from the start of the motion, and
based on the derived evaluation value, adjusts a content of the motion.

8. The information processing device according to claim 4, wherein the processor
performs a predetermined regression analysis using, as explanatory variables, detection results by sensors each being the sensor, the detection results being included in each of the pieces of correspondence information, thereby deriving a regression formula for the probability that the robot receives the action, and
derives the probability based on the derived regression formula and detection results by the sensors at a time point corresponding to the specific time point.

9. The information processing device according to claim 8, wherein the processor
derives the regression formula in response to a predetermined minimum number of pieces of correspondence information or more being stored in the storage, and
after deriving the regression formula, each time the processor stores a piece of correspondence information in the storage, updates the regression formula based on a plurality of pieces of correspondence information stored in the storage including the piece of correspondence information most recently stored.

10. An information processing method that is performed by a computer, comprising:
storing, in a storage, a piece of correspondence information in which a detection result by a sensor at a certain time point, the sensor being included in a robot for detecting at least one action from a user, is correlated with presence or absence of a predetermined action from outside to the robot within a predetermined period including the certain time point; and
based on pieces of correspondence information stored in the storage and corresponding to time points different from one another, the pieces of correspondence information each being the piece of correspondence information, making a prediction for an action that the robot receives from the user at a specific time point after the time points.

11. A non-transitory computer-readable storage medium storing a program causing a computer to:
store, in a storage, a piece of correspondence information in which a detection result by a sensor at a certain time point, the sensor being included in a robot for detecting at least one action from a user, is correlated with presence or absence of a predetermined action from outside to the robot within a predetermined period including the certain time point; and
based on pieces of correspondence information stored in the storage and corresponding to time points different from one another, the pieces of correspondence information each being the piece of correspondence information, make a prediction for an action that the robot receives from the user at a specific time point after the time points.
